(19) United States
(12) Patent Application Publication
(10) Pub. No.: US 2002/0027837 A1
(43) Pub. Date: Mar. 7, 2002

(54) Rewritable CD credit card

(76) Inventor: Warren D. Weber, Edmonds, WA (US)

Correspondence Address: Dean A. Craine, DEAN A. CRAINE, P.S., 400 112th Avenue NE, Suite 140, Bellevue, WA, 98004-5542, US

(21) Appl. No.: 09/945,098

(22) Filed: Aug. 31, 2001

Related U.S. Application Data
(60) Provisional application No. 60/230,170, filed on Sep. 1, 2000.

(51) Int. Cl. G11B 13/00

(52) U.S. Cl. 369/14

(57) ABSTRACT

The CD credit card includes vendor and cardholder information and a magnetic strip attached to the front surface designed to be used with a standard reading terminal. Formed on the rear surface is a CD media surface capable of being read in a standard CD-ROM player. In one embodiment, the CD media surface is a “multiple write and read” media surface capable of being produced by a CD-RW device. In a second embodiment, the CD media surface is in “write once, read many” media surface capable of being produced by a CD-R device. Formed centrally on the disc body is a spindle hole which enables the disc to be placed in a CD player. An optional plug may be inserted into the spindle hole.

This is a utility patent application based on the provisional patent application (Serial No. 60/230,170) filed on Sep. 1, 2000.

### BACKGROUND OF THE INVENTION

1. Field of the Invention

This invention pertains to debit and credit cards, and, more particularly, to debit and credit cards having means to selectively record data on them regarding the vendor, cardholder, or the account associated therewith.

2. Description of the Related Art

Debit and credit cards are widely used in our society in place of cash transactions. Many individuals carry little or no cash and use a debit or credit card for every large and small purchase. Debit and credit cards are generally wallet-sized cards made of semi-rigid plastic with the name of the vendor, the name of the cardholder, the account number, and the vendor code imprinted thereon.

One problem with debit or credit cards is that the user must remember to record the transaction in his or her account register. If the user forgets to record the transaction or loses the sales receipt, the total amount of funds in the account will not be accurately reflected in the account register. Also, if the sales receipt is lost, the item may not be returned for cash back or credit at many businesses.

All debit and credit cards include a reading means, such as a magnetic strip or bar code, that is passed through a reading terminal that identifies the name of the cardholder, the account number, the issuing bank, and a unique digital signature code. Typically, this information is recorded on two separate lines on the magnetic strip which also quickly and accurately reads to record the transaction.

In addition to its use for cash-less transactions, debit and credit cards may also be used for identification. Most cards include a signature line that must be signed by the cardholder for the card to be valid. During use, the store clerk is required to compare the signature on the card with the signed signature on the sales receipt. If the signatures do not match, the store clerk is instructed to confiscate the card or to ask for additional identification from the cardholder. Some cards also include a photograph of the cardholder for additional security.

CD-type business cards are commonly used by businesses to provide useful information to their customers and vendors regarding their businesses or the products and services they provide. CD-size business cards are small business-card-shaped CD-ROM (compact disc read only memory) discs designed to store both data and audio information. Like typical CD-ROM discs, they are made of polycarbonate with a base covered with a metallic recording media, usually an aluminum alloy. Business card information is printed on the non-recorded side of the disc and then covered with a protective polycarbonate coating. While standard CD-ROM discs are circular and 120 mm in diameter, 12 mm thick and have a 15 mm center hole, CD size business cards are approximately 80 mm in diameter between their curved sides, and hold approximately 50 MB of data. They are especially convenient because they may be easily manufactured in bulk quantities and carried in a standard size shirt pocket or wallet.

Recordable CD-ROM devices, hereinafter called CD-R devices, are now available which enable users to create their own CD-ROM discs. CD-R devices are WORM (write-once, read many) devices that permanently fill a CD-R disc with data once and can be read an unlimited number of times. The “write-once” limitation is preferable when permanent data is intended to be used over and over. An important feature of recorded CD-R discs is that they may be used in most standard CD-ROM devices.

Rewritable CD-ROM devices, hereinafter called CD-RW devices, are also available which enable users to write data onto a CD-RW disc up to approximately 1000 times. The CD-RW discs produced by CD-RW devices are generally readable by newer “multi-read” CD-ROM, CD-R, and CD-RW devices. While older CD-RW devices deleted the old contents on a CD-RW disc when rewriting, newer CD-RW devices are able to add data to existing data on the CD-RW disc, similar to a floppy disc.

What is needed is an improved debit or credit card that includes a reading means capable of being read by a standard electronic reading terminal for conducting, standard debit or credit card transactions, that also includes means for selectively recording desirable information, such as the vendor information, account information, receipts, payments, etc. directly on the card.

What is needed is such a card that can be used by a cardholder with his or her computer with currently available CD-ROM or CD-R or CD-RW devices.

### SUMMARY OF THE INVENTION

It is an object of the present invention to provide a debit or credit card that can be used in standard electronic or manual reading terminals for debit or credit card transactions.

It is another object of the present invention is to provide such a debit or credit card that includes a CD-ROM media surface on which useful account and transaction information may be saved and reviewed by a standard CD-ROM device.

It is another object of the invention to provide such a debit or credit card in which the media surface is a recordable surface capable of being written upon by a CD-R device or a rewritable surface capable of being written upon by CD-RW device.

These and other objects of the invention which will become apparent are met by a recording CD credit card with a machine readable means, such as standard magnetic strip, bar code, or Braille dots, attached, printed, or imprinted on its front surface to enable the card to be used with a standard electronic or manual reading terminal to conduct standard debit or credit card transactions. In the preferred embodiment, the machine-readable means is a standard, magnetic strip which is swiped or passed through an electronic card reader terminal.

Formed on the opposite surface of the card is a CD-ROM media surface. The CD-ROM media surface may be a “read only” media, a “write once, read many” media, or a “multiple write and read” media all capable of being read by a “multi-read” CD-ROM device, a CD-R device, or a CD-RW device, respectively. When the “multiple write and read” media is used, it is possible to erase what has been previously recorded and re-record again over the top of it. It is also possible to write additional data to existing data already recorded on the media. How many times it can be rewritten depends on the specification of the rewritable layer.

The CD media surfaces consist of standard components and methods used in the prior art which are incorporated herein. For example, with the “multiple write and read” medium, the rewritable medium comprises current CD-R technology which uses chemicals that undergo a phase change from a crystalline to a non-crystalline stage to alter its state from a reflective state to a light absorbing state, respectively. With the “write once, read many” medium, the recordable medium uses current CD RW technology which uses dyes that undergo reflective changes.

The card is approximately the size and shape of a standard business card with two parallel, flat, top and bottom edges and two opposite equally curved side edges. The card includes a standard 15 mm central hole that receives the spindle on a standard CD-ROM device. The central hole also receives a removable plug that creates a complete printable surface and also serves as a tamper and theft resistant feature.

The CD-credit card is especially useful because it may be placed in the cardholder's CD-ROM device to review a plurality of account information, such as the vendor's account information, addresses, telephone numbers, billing policies and the cardholders' account information. If a rewritable medium is provided, individual sale transactions and payments may be repeatedly recorded directly on the card, which may be reviewed later on a standard CD-ROM device.

### BRIEF DESCRIPTION OF THE DRAWINGS

FIG. 1 is a top plan view of the CD-credit card disclosed herein.

FIG. 2 is a back plan view of the CD-credit card with a “read only” medium surface.

FIG. 3 is a back plan view of the CD-credit card with a “write once, read many” medium surface.

FIG. 4 is a back plan view of the CD-credit card with a “multiple write and read” medium surface.

### DESCRIPTION OF THE PREFERRED EMBODIMENT(S)

Referring to the accompanying Figs., a CD credit card, generally denoted by 10, with a machine readable means, such as standard magnetic strip 20, attached, printed, or imprinted on its front surface 12 to enable the card 10 to be used with a standard electronic or manual reading terminal to conduct standard debit or credit card transactions. In the preferred embodiment, the machine-readable means is a standard, magnetic strip 20 which is swiped or passed through an electronic card reader terminal. It should be understood, however, that other types of means, such as bar code or raised Braille dots, could be used in place thereof and used in the same purpose.

Printed on the front surface 12 of the card 10 is the issuing entity's indicia 14, the cardholder's name 16, the signature line 17, the account number 18, and expiration date information 19. Formed centrally on the card 10 is a hole 40 approximately 15 mm in diameter which is designed to receive the spindle of a CD-ROM device, CD-R device or CDRW device during use.

Formed on the back surface 30 of the card 10 is a CD-ROM media surface. In the embodiment shown in FIG. 2, the CD-ROM media surface may be a “read only” media surface 32 designed for viewing data permanently stored thereon by the issuing entity. In the embodiment shown in FIG. 3, the “read only” media surface 32 is replaced with a “write once, read many” media surface 34 designed to allow the issuing entity or user to record data once on the card that can be viewed multiple times. In FIG. 4, a third embodiment is shown in which the CD-ROM media surface is a “multiple write and read” media surface 36 capable of being written upon repeatedly by a CD-RW device and read by any “multi-read” CD-ROM device. When the “multiple write and read” CD-ROM media surface 36 is used, individual sales and payment transactions may be recorded on the card and then viewed later by the user.

The CD media surfaces 32, 34, 36 are manufactured using standard components and methods used in the prior art which are incorporated herein. For example, the “multiple write and read” or rewritable media surface 36 comprises current CD-RW technology which uses chemicals that undergo a phase change from a crystalline to a non-crystalline stage to alter its state from a reflective state to a light absorbing state, respectively. With the “write once, read many” media surface 34, the recordable media surface uses dyes that undergo reflective changes.

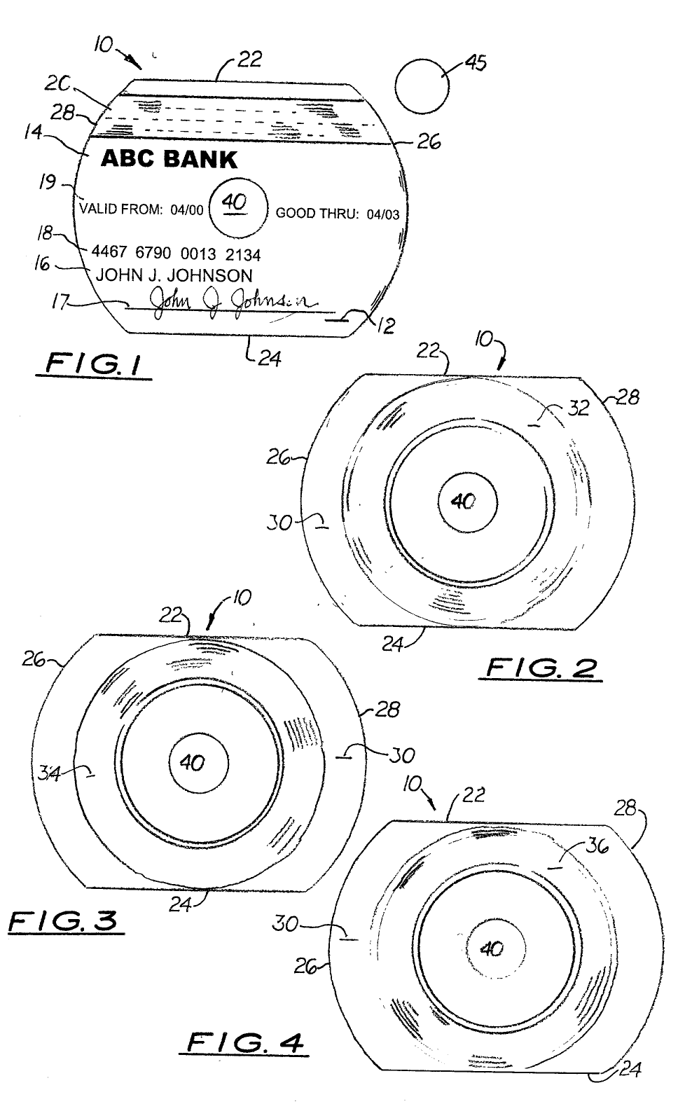

As shown in FIG. 1, the card 10 is approximately the size and shape of a standard business card with two parallel, flat, top and bottom edges 22, 24 and two opposite equally curved end edges 26, 28. The card 10 may be accompanied by a removable plug 45 which fits snuggly into the hole 40 to create a complete printable surface and also serves as a tamper and theft resistant feature.

### Industrial Use

Any business that issues a credit, debit, or account-associated card, such as a bank, credit union, department store, or medical insurance company, may find the card useful. The CD credit card may be used to transmit important general account information, addresses, telephone numbers, website addresses, and password security information to the cardholder. When the “multiple write and read” media surface is used, the issuing entity can easily change the information on the card and record individual transaction directly on the card thereby eliminating printed receipts.

When used with the medical insurance industry, the card can also be used to hold the patient's medical records, medication profiles, and emergency care requirements. The cardholder and healthcare provider could then download the information.

In compliance with the statute, the invention described herein has been described in language more or less specific as to structural features. It should be understood, however, that the invention is not limited to the specific features shown, since the means and construction shown, comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A CD credit card, comprising:
a. a CD disc body being substantially the size of a credit card having front and opposite back surfaces, said disc body having a central spindle hole to enable said disc body to be used in a CD player;
b. credit card account information located on said front surface of said CD disc body;
c. a CD media surface formed on said back surface of said disc body.

2. The CD credit card, as recited in claim 1, wherein said credit card account information is located on a magnetic strip attached to said front surface and capable of being read by a magnetic strip reading terminal.

3. The CD credit card, as recited in claim 1, wherein said CD media surface is a multiple write and read recordable media surface.
